(19) United States
(12) Patent Application Publication
(10) Pub. No.: US 2008/0214254 A1
(43) Pub. Date: Sep. 4, 2008

(54) Gaming machine and playing method thereof

(75) Inventor: Kazumasa Yoshizawa, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 12/000,562

(22) Filed: Dec. 13, 2007

(30) Foreign Application Priority Data
Dec. 14, 2006 (JP) JP2006-337164

(51) Int. Cl. A63F 13/00; A63F 9/24; G06F 19/00; G07F 17/34

(52) U.S. Cl. 463/7; 463/20

(57) ABSTRACT

A gaming machine comprising: a display that arranges a plurality of symbols; an effect device that comprises a ball to be dropped and a plurality of pins with which the ball collides while being dropped; and a controller that operates (a) to rearrange the symbols; (b) to determine a win based on a relation of the symbols rearranged; (c) to drop the ball when a predetermined condition is fulfilled; and (d) to award a payout when the dropped ball reaches a specific location.

### CROSS REFERENCE TO RELATED APPLICATION

This application is based upon and claims the benefit of priority from the prior Japanese Patent Applications No. 2006-337164, filed on Dec. 14, 2006, the entire contents of which are incorporated herein by reference.

### BACKGROUND OF THE INVENTION

1. Field of the Invention

The invention relates to a gaming machine and a playing method thereof.

2. Description of Related Art

In a conventional gaming machine, when a player inserts a game medium such as coin or bill into an insertion slot and presses a spin button, symbols are scroll-displayed in a display mounted on a front of a cabinet and the respective symbols are then stopped automatically.

In conventional gaming machines, for example, when the symbols stopped on a winning line constitute a predetermined combination, the predetermined number of game media are paid out (refer to U.S. Pat. No. 6,604,999 B2, U.S. Patent No. 2002065124A1). In addition, when a certain symbol referred to as scattered symbol is displayed on the display, the predetermined number of game media are paid out as a win in accordance with the number of scattered symbols displayed, irrespective of the winning line stopped on the winning like.

The conventional gaming machine determines a win for each unit game. Therefore, the gaming machine is structured to stop the symbols in a display form corresponding to the determined win. In other words, the conventional gaming machine does not accidentally award a payout, except the determined win.

### SUMMARY OF THE INVENTION

The invention is to provide a gaming machine having an entertainment characteristic, which is not provided to the prior art, and a playing method thereof. That is, the invention is to provide a gaming machine having a new entertainment characteristic that a payout may be accidentally awarded, and a playing method thereof.

According to a first aspect of the invention, there is provided a gaming machine comprising: a display that arranges a plurality of symbols; an effect device that comprises a ball to be dropped and a plurality of pins with which the ball collides while being dropped; and a controller that operates (a) to rearrange the symbols; (b) to determine a win based on a relation of the symbols rearranged; (c) to drop the ball when a predetermined condition is fulfilled; and (d) to award a payout when the dropped ball reaches a specific location.

According to a second aspect of the invention, there is provided a playing method of a gaming machine that repeatedly performs a unit game in which a plurality of symbols are rearranged, the method comprising the steps of: executing a bonus game in which a ball is dropped while colliding with a plurality of pins, when a predetermined condition is fulfilled; and awarding a payout when the dropped ball reaches a specific location.

According to the gaming machine and the playing method thereof of the first and second aspects of the invention, when a predetermined condition is fulfilled, a ball is physically dropped in an effect device. When the dropped ball reaches a specific location, a payout is awarded. In other words, according to the gaming machine and the playing method thereof, a payout may be accidentally awarded. Accordingly, the gaming machine and the playing method thereof can provide a new entertainment characteristic.

### BRIEF DESCRIPTION OF THE DRAWINGS

Other and further objects, features and advantages of the invention will appear more fully from the following description taken in connection with the accompanying drawings, in which:

FIG. 1 illustrates a playing method of a gaming machine;

FIG. 2 is a block diagram of a gaming machine;

FIG. 3 illustrates a display screen;

FIG. 4 shows symbols and code numbers thereof;

FIG. 5 illustrates a structure of an effect device;

FIG. 6 is a perspective view showing an external appearance of a gaming machine;

FIG. 7 is a block diagram showing a main control substrate of a gaming machine;

FIG. 8 is a block diagram showing a sub-control substrate of a gaming machine;

FIG. 9 is a flow chart of a game executing process; and

FIG. 10 is a flow chart of a bonus game process.

### DESCRIPTION OF THE PREFERRED EMBODIMENTS

Hereinafter, it will be described an embodiment of a gaming machine and a playing method according to the invention with reference to the drawings.

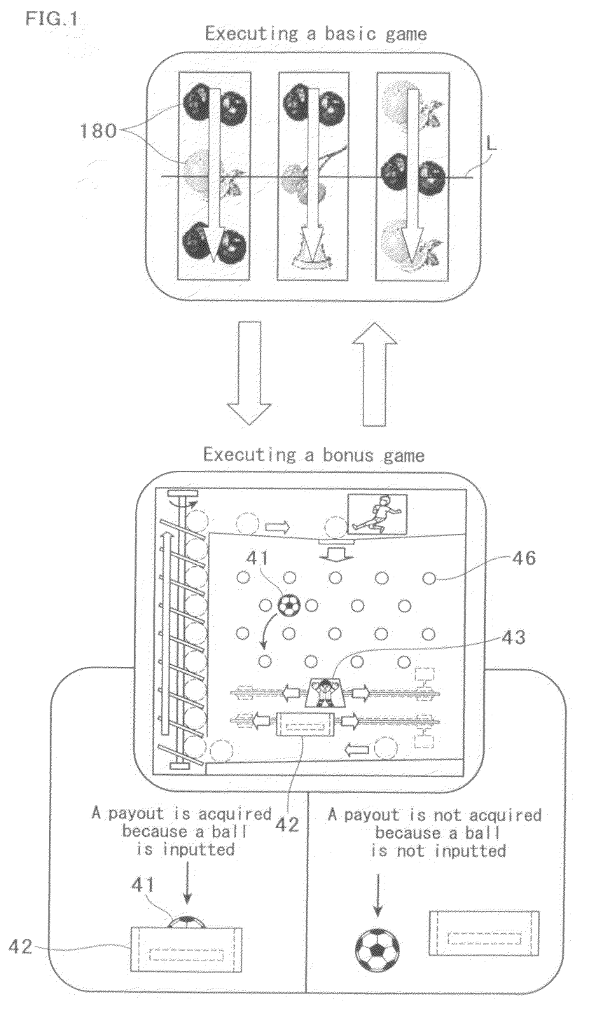

As shown in FIG. 1, a gaming machine executes a playing method according to the embodiment when a predetermined condition is fulfilled. The playing method according to the embodiment comprises the steps of: dropping a ball 41 while the ball collides with pins 46, and horizontally moving a receiver 42 capable of receiving the ball 41 and an inhibitor 43 that inhibits the ball 41 from being received in the receiver 42; and awarding a payout when the dropped ball 41 is received in the receiver 42. In addition, in the invention, the inhibitor 43 may not be provided to the gaming machine.

Herein, the fulfillment of a “predetermined condition” means a case where a bonus game different from a basic game is executed, in this embodiment. In other words, in a bonus game, the gaming machine physically drops the ball 41. The ball 41 is dropped while colliding with the pins 46 and thus changing the dropping direction. When the ball 41 is received in the receiver 42 being horizontally moved, the gaming machine awards a payout in the bonus game.

(Indicator 101)

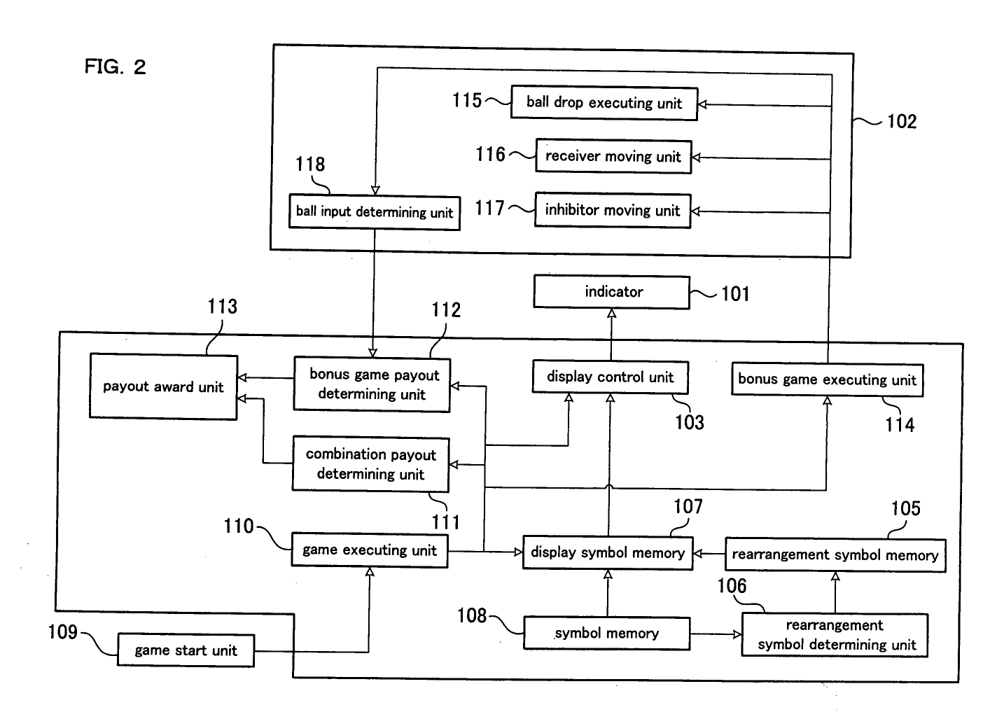

As shown in FIG. 2, the gaming machine executing the playing method comprises an indicator (display) 101, an effect device 102 and a controller 100. The indicator 101 is configured to arrange the symbols.

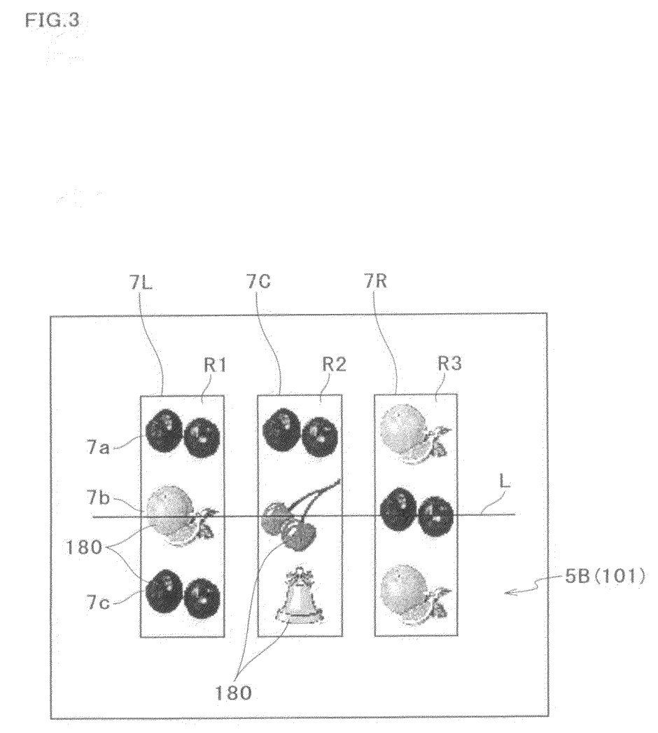

Herein, the “arrangement” means a state in which the symbols are allowed to be visible with naked eyes of an exterior player. In other words, as shown in FIG. 3, the symbols 180 are under state of being displayed in display windows 7L, 7C, 7R. In the mean time, the “rearrangement” means arranging the symbols 180 again after dismissing the arrangement of the symbols 180.

The indicator 101 may be a mechanical structure with a reel device comprising a rotatable reel having symbols depicted thereon and arranging the symbols by rotation of the reel or electrical structure with a video reel on which an image is displayed for arranging the symbols. Further, the indicator 101 may be a structure of combining a mechanical structure (for example, reel device) and an electrical structure (for example, video reel). The electrical structure may use a liquid crystal display device, a CRT (cathode-ray tube) device, a plasma display and the like for the image display. A detailed structure of the indicator 101 will be described later.

(Controller 100)

The controller 100 executes a first process of rearranging the symbols 180 and a second process of determining a win by a relation of the symbols 180 rearranged. In other words, the controller 100 comprises a first processing unit that executes the first process and a second processing unit that executes the second process. In addition, the controller 100 executes a third process of dropping a ball 41 and horizontally moving a receiver 42 and an inhibitor 43 when a predetermined condition is fulfilled, and a fourth process of awarding a payout when the dropped ball 41 is received in the receiver 42. In other words, the controller 100 comprises a third processing unit that executes the third process and a fourth processing unit that executes the fourth process. Meanwhile, a game that is executed in the first process and the second process is referred to as a basic game, and a game that is executed in the third process and the fourth process is referred to as a bonus game.

As shown in FIG. 2, the controller 100 comprises a symbol memory 108 for storing all symbols 180 and a display symbol memory 107 for storing the symbols 180 in the symbol memory 108 as a display symbol. The display symbol memory 107 can be accessed by a display control unit 103. The display control unit 103 reads out the symbols 180 stored in the display symbol memory 107 under control of a game executing unit 110 and displays the symbols 180 in the indicator 101. A detailed display state in the indicator 101 will be described later.

In addition, the controller 100 comprises a rearrangement symbol determining unit 106 that determines symbols to be rearranged every unit game, based on the symbols 180 stored in the symbol memory 108. The symbols to be rearranged, which are determined by the rearrangement symbol determining unit 106, are stored in a rearrangement symbol memory 105. The symbols to be rearranged, which are stored in the rearrangement symbol memory 105, are outputted to the display symbol memory 107 and are then image-processed in the display control unit 103, so that they are displayed in the indicator 101. In other words, the controller 100 executes the first process of rearranging the symbols 180 every unit game in the indicator 101.

Furthermore, the controller 100 is connected to a game start unit 109. The game start unit 109 outputs a game start signal, based on an operation of the player. The controller 100 comprises a game executing unit 110, a combination payout determining unit 111 and a payout award unit 113. The game executing unit 110 executes a unit game in which the symbols 180 are rearranged with a game start signal, as trigger, from the game start unit 109. The combination payout determining unit 111 determines a payout that is determined by a combination of the symbols 180 rearranged in the game executing unit 110. The payout award unit 113 awards each payout determined in the combination payout determining unit 111. In other words, the controller 100 executes the second process of determining a win on the basis of a relation of the symbols 180 rearranged.

In addition, the controller 100 comprises a bonus game executing unit 114 and a bonus game payout determining unit 112. The bonus game executing unit 114 controls the driving of the effect device 102 when a predetermined condition is fulfilled, i.e., when a bonus game is executed. In other words, the controller 100 executes the third process of dropping a ball 41 and horizontally moving a receiver 42 and an inhibitor 43 when a predetermined condition is fulfilled. The bonus game payout determining unit 112 determines a payout that is awarded to a player when a payout is awarded in a bonus game. The payout award unit 113 awards the payout determined in the bonus game payout determining unit 112. In other words, the controller 100 executes the fourth process of awarding a payout when the dropped ball 41 is received in the receiver 42.

In the mean time, each block of the controller 100 shown in FIG. 2 may be structured with a hardware or software, as required.

(Effect Device 102)

As shown in FIG. 2, the effect device 102 comprises a ball drop executing unit 115, a receiver moving unit 116, an inhibitor moving unit 117 and a ball input determining unit 118. The ball drop executing unit 115 drops the ball 41. The receiver moving unit 116 horizontally moves the receiver 42. The inhibitor moving unit 117 horizontally moves the inhibitor 43. The ball input determining unit 118 determines whether the ball 41 is received in the receiver 42. The ball drop executing unit 115, the receiver moving unit 116, the inhibitor moving unit 117 and the ball input determining unit 118 are controlled by the bonus game executing unit 114 of the controller 100. The bonus game determining unit 112 of the controller 100 determines a payout in a bonus game when the ball input determining unit 118 determines that the ball 41 is received in the receiver 42.

(Operation of the Controller 100)

In the followings, an operation of the controller 100 will be described. Firstly, the rearrangement symbol determining unit 106 determines the symbols to be rearranged and stores the determined symbols to be rearranged in the rearrangement symbol memory 105. The symbols to be rearranged, which are stored in the rearrangement symbol memory 105, are stored in the display symbol memory 107. The symbols to be rearranged, which are stored in the display symbol memory 107, are enabled to be displayed in the indicator 101 by the display control unit 103. When the game executing unit 110 executes a unit game, the symbols to be rearranged, which are stored in the display symbol memory 107, are displayed in the indicator 101, so that the symbols 180 are rearranged. Thereby, the controller 100 executes the first process of rearranging the symbols 180.

Then, the combination payout determining unit 111 and the payout award unit 113 determine a win, based on a relation of the symbols 180 rearranged, and awards a payout based on the win. Thereby, the controller 100 executes the second process of determining a win based on a relation of the symbols 180 rearranged.

In addition, when a bonus game is executed, the effect device 102 executing the bonus game is controlled by the bonus game executing unit 114. Thereby, the controller 100 executes the third process of dropping the ball 41 and horizontally moving the receiver 42 and the inhibitor 43 when a predetermined condition is fulfilled.

When the ball input determining unit 118 determines that the ball 41 is received in the receiver 42, the bonus game payout determining unit 112 and the payout award unit 113 award a payout in a bonus game. Thereby, the controller 100 executes the third process of awarding a payout when the dropped ball 41 is received in the receiver 42.

As can be clearly seen from the above operation of the controller 100, the gaming machine 1 realizes the playing method of when a predetermined condition is fulfilled, dropping the ball 41 while colliding the ball with pins 46, horizontally moving the receiver 42 capable of receiving the ball 41 and the inhibitor 43 inhibiting the ball 41 from being received in the receiver 42, and awarding a payout when the dropped ball 41 is received in the receiver 42 (refer to FIG. 1).

In the playing method of the gaming machine 1, a bonus game is executed in which the ball 41 is physically dropped, in addition to the basic game. In the bonus game, when the dropped ball 41 is received in the receiver 42 being horizontally moved, a payout is awarded. In other words, since a case may occur where a payout is accidentally awarded, a new entertainment characteristic can be provided.

(Display Aspect)

It will be specifically described an example of a display aspect of the indicator 101, with respect to the operation processes of the gaming machine 1 and the playing method. In the mean time, as shown in FIG. 3, the display aspect is described with reference to the indicator 101 having a mechanical structure (reel manner of arranging the symbols with a reel device).

The indicator 101 has display windows 7L, 7C, 7R as an arrangement area for arranging the symbols 180. The display windows 7L, 7C, 7R are disposed in a central part of the indicator 101. In the display windows 7L, 7C, 7R, the reels R1, R2, R3, on which symbol columns consisting of the symbols 180 are depicted, are rotated and displayed (refer to FIG. 1). In addition, each of the display windows 7L, 7C, 7R is divided into upper, central and lower stages 7a, 7b, 7c. As each reel R1, R2, R3 is stopped, each of the symbols 180 is stopped (arranged) in the respective stages 7a, 7b, 7c of the display windows 7L, 7C, 7R. For example, in FIG. 3, “PLUM” is stopped in the upper stage 7a of the display window 7L, “ORANGE” is stopped in the central stage 7b of the display window 7L and “PLUM” is stopped in the lower stage 7c of the display window 7L. As a result, the display windows 7L, 7C, 7R display a symbol matrix consisting of 3 columns and 3 rows. In the mean time, the symbol matrix is not limited to 3 columns/3 rows.

In addition, in the indicator 101, a payline L is provided which horizontally traverses the central stages 7b of the respective display windows 7L, 7C, 7R. The payline L is provided to determine a combination of the symbols 180. In other words, when the symbols 180 are rearranged on and out of the payline L, a combination is determined only for the symbols 180 rearranged on the payline. As a result of the determination for a combination, when it is made a winning combination, it is carried out, for example, a process of paying out a coin in accordance with the winning combination.

In the mean time, in the gaming machine 1 and the playing method thereof according to this embodiment, when the symbols stopped on the payline L, which is provided in the indicator 101, are a predetermined combination, a process of paying out a coin is carried out, for example. However, the gaming machine 1 and the playing method thereof may perform a process of paying out a coin when a predetermined number of symbols referred to as a scattered symbol is displayed in the indicator 101, irrespective of the payline L.

(Symbol, Combination and the Like)

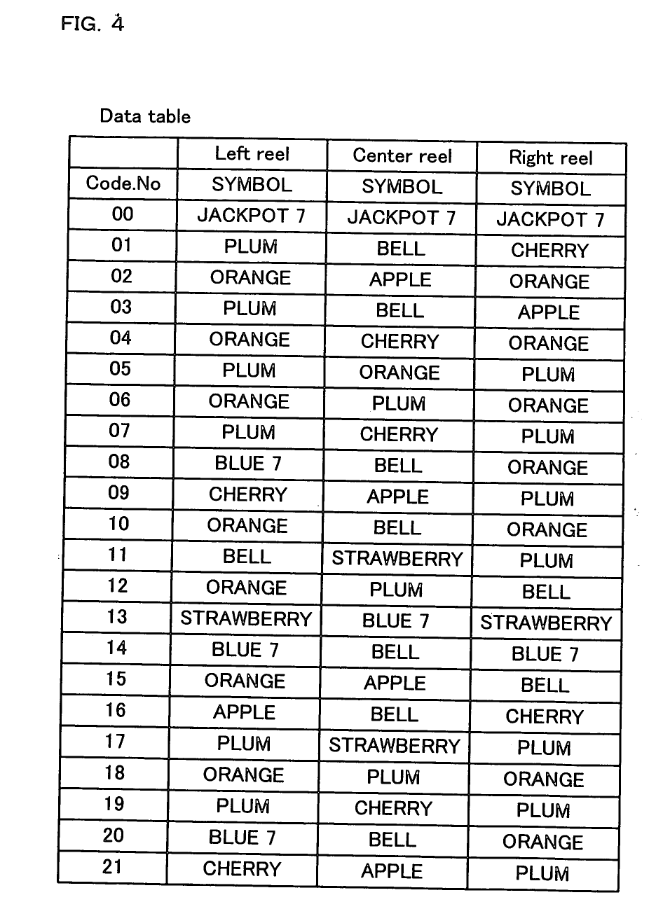

As shown in FIG. 4, 22 symbols constituting the symbol columns are depicted on each of the left reel R1, the center reel R2 and the right reel R3. The symbols constituting the respective symbol columns are given with one code number of 0˜21. Each of the symbol columns is constituted with a combination of symbols of “JACKPOT 7,” “BLUE 7,” “BELL,” “CHERRY,” “STRAWBERRY,” “PLUM,” “ORANGE” and “APPLE.”

The three successive symbols in the symbol columns are displayed (arranged) in the upper, central and lower stages 7a, 7b, 7c of the display windows 7L, 7C, 7R, respectively, so that they constitute a symbol matrix of 3 columns/3 rows in the display windows 7L, 7C, 7R. When a BET button is pushed and then a start button is pushed to start a game, the symbol columns depicted on the respective reels R1, R2, R3 are scroll-displayed in the display windows 7L, 7C, 7R in the downward direction as the reels R1, R2, R3 are rotated. After a predetermined time period has elapsed, when the rotation of the reels R1, R2, R3 are stopped, the symbol columns of the respective reels R1, R2, R3 are stopped in the display windows 7, so that the symbols are rearranged.

In addition, various winning combinations are predetermined with regard to the respective symbols. The winning combination is a combination that a combination of symbols stopped on the payline L becomes an advantageous state to the player. The advantageous state is a state in which a coin is paid out in accordance with the winning combination, a state in which the payout-number of coins is added to a credit, a state in which a bonus game is started, and the like.

Specifically, in this embodiment, when a combination of “APPLE” symbol is stopped, as a winning combination, on the payline L, the combination becomes a bonus trigger, and a bonus game is thus executed. In addition, when a symbol of “CHERRY” is stopped, as a winning combination, on the payline L, 20 coins (game medium) are paid out per one bet. Furthermore, when a symbol of “PLUM” is stopped, as a winning combination, on the payline L, 5 coins are paid out per one bet. In addition, the winning combination is not limited thereto.

In the mean time, a payout in a bonus game may be supplied by all or a part of payout for a jackpot. In other words, an amount of money of a predetermined percentage of the amount of money consumed in a unit game is accumulated as a payout every unit game. When a combination of “JACKPOT 7” symbol is stopped on the payline L, all of the accumulated payout for jackpot is paid out. In addition, when a payout in a bonus game is awarded, all or a part of the payout for jackpot may be awarded as a payout in a bonus game. Meanwhile, the payout for jackpot may be an amount of money having summed the payouts for jackpot accumulated every unit game in each of the gaming machines 1 connected to a network.

(Structure of the Effect Device 102)

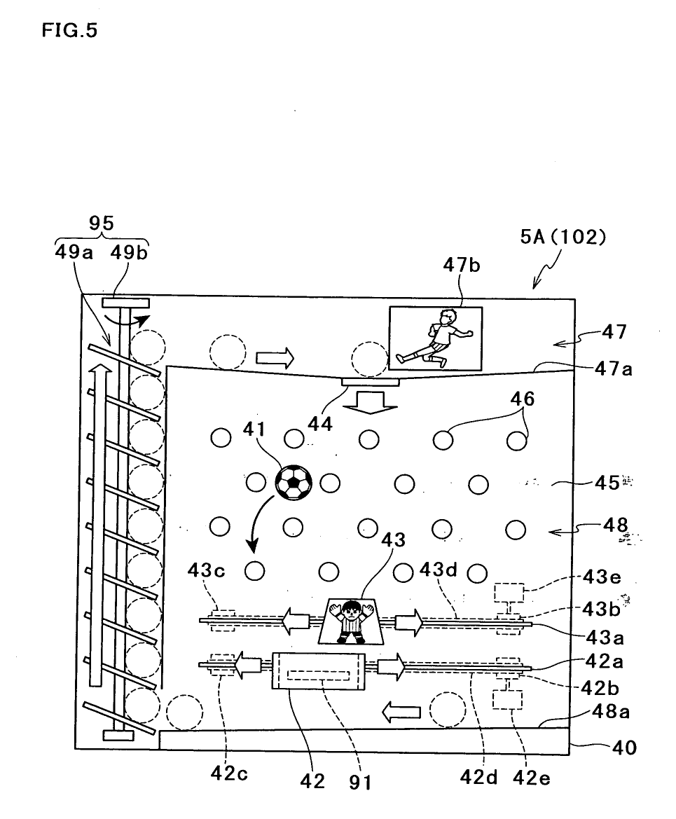

As shown in FIG. 5, the effect device 102 has a box-shaped cabinet 40. The cabinet 40 is structured so that the ball 41 is dropped therein.

As shown in FIG. 5, the cabinet 40 of the effect device 102 is provided therein with a storage area 47, an opening/closing hole 44, a drop area 48 and a collection device 95. The storage area 47 stores the soccer ball-shaped ball 41. The opening/closing hole 44 is opened/closed by an opening/closing device 92, thereby dropping the ball 41 stored in the storage area 47. The drop area 48 is an area in which the ball 41 is dropped. The collection device 95 collects the ball 41 having passed to the drop area 48 into the storage area 47.

The storage area 47 is provided with a partition wall 47a and a block component 47b. The partition wall 47a isolates the storage area 47 and the drop area 48 and is downward inclined toward the central part. In addition, a center of the partition wall 47a is formed with the opening/closing hole 44. The block component 47b is formed above the inclined part of the opening/closing hole 44, and a soccer player, for example is depicted on its front face. The ball 41 moved to the storage area 47 by the collection device 95 rotates the partition wall 47a, so that it is moved above the opening/closing hole 44, is contacted to the block component 47b and is located above the opening/closing hole 47.

The drop area 48 is provided to a front face of a back plate 45 and has the pins 46, the receiver 42, the inhibitor 43 and a bottom wall 48a. The pins 46 are stuck in the front face of the back plate 45. The receiver 42 is formed to receive the ball 41. The inhibitor 43 is formed above the receiver 42 and inhibits the ball 41 from being received in the receiver 42. The bottom wall 48a is inclined diagonally left down so that the ball 41 having passed to the drop area 48 is rotated in the left direction.

A back face of the back plate 45 is provided with a receiver moving device 93 at a position corresponding to the receiver 42. The receiver moving device 93 comprises a driving roller 42b, a driven roller 42c, a belt 42d and a stepping motor 42e. The belt 42d is horizontally laid between the two rollers 42b, 42c. The stepping motor 42e rotates the driving roller 42b. In addition, the back plate 45 is formed a horizontal slit 42a. The receiver 42 is connected to a part of the belt 42d by a connection component (not shown) passing through the slit 42a toward the back face from the front face of the back plate 45. The driving roller 42b is rotated by the stepping motor 42e to drive the belt 42d in the right or left direction. Thereby, the connection component connecting the receiver 42 and the belt 42d is moved in the right or left direction in the slit 42a. By the receiver moving device 93, the receiver 93 corresponding to a soccer ball is horizontally moved along the slit 42a in the drop area 48. In addition, a sensor 91 that senses the ball 41 is provided in the receiver 42. Meanwhile, the receiver 42 of this embodiment is formed into a tank shape having upper and lower parts opened, considering the collection of the ball 41. Due to this, the ball 41 having entered the receiver 42 passes to the inside of the receiver 42 and reaches the bottom wall 48a. Accordingly, in this embodiment, the receiving means that the ball 41 enters the receiver 42.

In addition, an inhibitor moving device 94 is provided to the back face of the back plate 45 at a position opposite to the inhibitor 43 having a front face on which a goalkeeper is depicted. The inhibitor moving device 94 is structured same as the receiver moving device 93, so that its description is omitted. By the inhibitor moving device 94, the inhibitor 43 is horizontally moved along the slit 43a in the drop area 48.

The collection device 95 is screw-shaped at the left position of the storage area 47 and the drop area 48. The collection device 95 consists of a screw device 49a that delivers the ball 41 upward by rotation, and a motor 49b that rotates the screw device 49a. The ball 41, which is rotation-moved to the left on the bottom wall 48a, is upward delivered as the screw device 49a is rotated, so that it is collected in the storage area 47.

In such effect device 102, a bonus game is executed. In the bonus game, the ball 41 stored in the storage area 47 is dropped from the opening/closing hole 44 and collides with the pins 46 in the drop area 48, so that it is dropped while changing the dropping direction randomly. In the mean time, the receiver 42 and the inhibitor 43 are horizontally moved at the lower part of the drop area 48 and the ball 41 may be thrown away due to the collision or may pass to the inside of the receiver 42. When the ball 41 passes to the inside of the receiver 42, the ball 41 is sensed by the sensor 91. The ball 41 having reached the bottom wall 49a is rotated in the left direction on the bottom wall 48a and is then collected in the storage area 47 by the collection device 95.

(Mechanical Structure of the Gaming Machine 1)

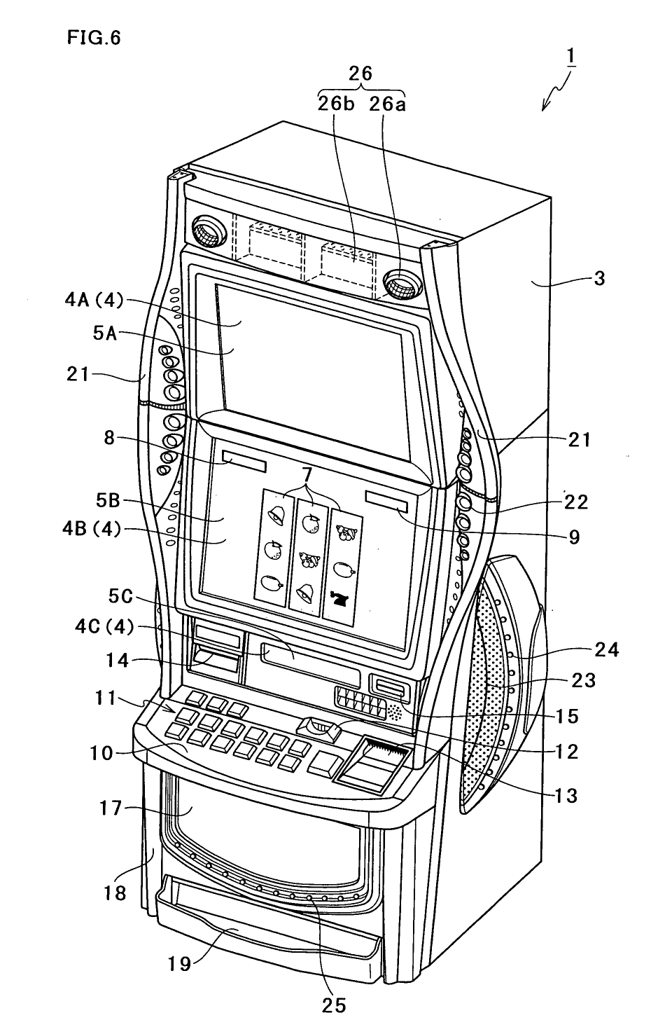

In the followings, a mechanical structure of the gaming machine 1 according to an embodiment of the invention will be described with reference to FIG. 6.

As shown in FIG. 6, the gaming machine 1 is an upright-type gaming machine provided in a game arcade such as casino and the like. The gaming machine 1 has a cabinet 3 for receiving electrical or mechanical parts so as to execute a predetermined game aspect. To a front face of the cabinet 3 that is longitudinally long is attached an indicator 4 for displaying the game information based on a game operation of a player. The indicator 4 comprises an upper variable indicator 4A, a central variable indicator 4B and a lower variable indicator 4C, for example. In this embodiment, each of the indicators 4A, 4B, 4C is attached to the front face of the cabinet 3 that is longitudinally long.

The upper variable indicator 4A is provided with an effect device 5A (102) for executing a bonus game.

The central variable indicator 4B is a rotating symbol display panel on which a player always fixes the eyes and has a transparent liquid crystal panel 5B that is fixed to a front door of the cabinet 3. To the liquid crystal panel 5B are provided three transparent display windows 7L, 7C, 7R. The symbols of the three reels R1, R2, R3 provided in the cabinet 3 can be seen from an outside through the respective display windows 7L, 7C, 7R. In addition, one payline L, which horizontally traverses the three display windows 7L, 7C, 7R, is displayed in the liquid crystal panel 5B. In the liquid crystal panel 5B, an effect such as moving picture is performed when a winning is made, for example. In addition, a payout-number indicator 8 and a credit-number indicator 9 are displayed in an upper part of the liquid crystal panel 5B.

The lower variable indicator 4C has a liquid crystal panel 5C that displays a point-number recorded in a card or a point-number of a game. A numerical value displayed in the liquid crystal panel 5C is based on a display result of the central variable indicator 4B. For example, when a winning combination is made in the central variable indicator 4B, a point-number of a game displayed in the liquid crystal panel 5C is added on the basis of the winning combination made. In addition, a ticket printer 14 is provided to a left side of the liquid crystal panel 5C. Further, a card reader 15 is provided to a right side of the liquid crystal panel 5C.

An operating table 10 that protrudes forward from the front face of the cabinet 3 is disposed below the lower variable indicator 4C. On the operating table 10, there are arranged operating buttons 11 (for example, bet button, collect button, start button, stop button and the like) as an operating unit enabling a player to operate a game. In addition, a coin insertion slot 12 and a bill insertion slot 13 are provided to the operating table 10.

A waist-position panel 17 is disposed below the operating table 10. The waist-position panel 17 is a plastic panel having a game-related image printed thereto. The waist-position panel 17 is fixed to a lower front door 18 and illuminated by a cold cathode-ray tube. In addition, a coin tray 19, which collects coins paid out on the basis of a game result, is disposed below the waist-position panel 17.

Furthermore, a light-emitting unit 20 is disposed to the cabinet 3 of the gaming machine 1 so that it surrounds a game area including the upper variable indicator 4A, the central variable indicator 4B, the lower variable indicator 4C and the operating table 10. The light-emitting unit 20 comprises side lamps 22, speaker lamps 24, under lamps 25 and top lamps 26. The side lamps 22 are provided to inclined parts 21 of a bow shape. The inclined parts 21 are sideways protruded at left and right ends of the cabinet 3 over all the variable indicators 4A, 4B, 4C. The speaker lamps 24 are arranged along edges of arc-shaped speakers 23. The speakers 23 are sideways protruded at the right and left ends of the cabinet 3 adjacent to the operating table 10. The under lamps 25 are arranged at a lower front door 18 along lower edges of the waist-position panel 17. The top lamps 26 have power lamps 26a and band-shaped lamps 26b. The power lamps 26a are disposed at both sides of an upper part of the upper variable indicator 4A. The band-shaped lamps 26b are arranged in a horizontal direction at a center of the upper part of the upper variable indicator 4A.

(Electrical Structure of the Gaming Machine 1)

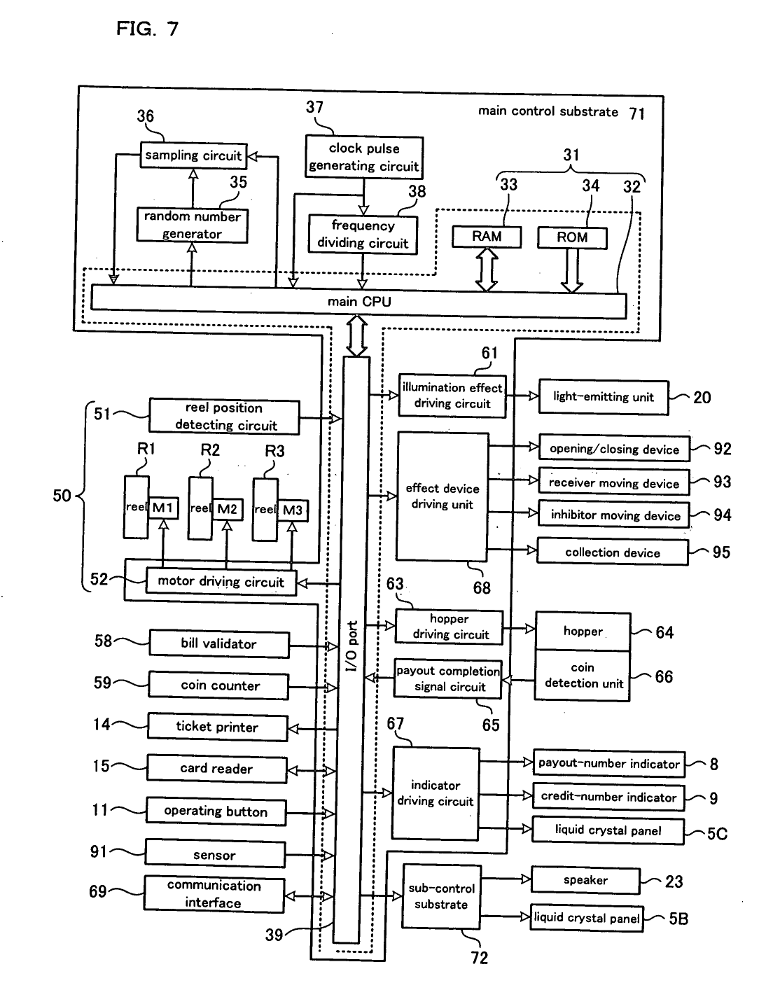

In the followings, an electrical structure of the gaming machine according to an embodiment of the invention will be described with reference to FIG. 7. FIG. 7 is a block diagram showing an entire electrical structure of the gaming machine 1. As shown in FIG. 7, the gaming machine 1 has many components about a main control substrate 71 including a microcomputer 31. The main control substrate 71 has a microcomputer 31, a random number generator 35, a sampling circuit 36, a clock pulse generating circuit 37 and a frequency dividing circuit 38.

The microcomputer 31 has a main CPU 32, a RAM 33 and a ROM 34. The main CPU 32 operates in accordance with a program stored in the ROM 34 and executes an input/output of a signal to and from the other components through an I/O port 39, thereby controlling an overall operation of the gaming machine 1. The RAM 33 stores data or program that is used when the main CPU 32 operates. For example, after a game starts, a random number value that is sampled by the sampling circuit 36 is temporarily maintained in the RAM 33 or the code numbers of the reels R1, R2, R3 are stored in the RAM 33. The ROM 34 stores a program that is executed by the main CPU 32 and permanent data.

The random number generator 35 generates a random number within a predetermined range in accordance with an instruction of the main CPU 32. The sampling circuit 36 samples any random number of the random numbers that are generated by the random number generator 35 in accordance with an instruction of the main CPU 32 and inputs the sampled random number into the main CPU 32. The clock pulse generating circuit 37 generates a reference clock for operating the main CPU 32. The frequency dividing circuit 38 inputs a signal, which is divided in a predetermined period based on the reference clock generated by the clock pulse generating circuit 37, to the main CPU 32.

In addition, the main control substrate 71 is connected with a reel driving unit 50. The reel driving unit 50 has a reel position detecting circuit 51 and a motor driving circuit 52. The reel position detecting circuit 51 detects each position of the reels R1, R2, R3. The motor driving circuit 52 inputs a driving signal to motors M1, M2, M3 for rotating the respective reels R1, R2, R3. When the driving signal is inputted from the motor driving circuit 52, the motors M1, M2, M3 are operated to rotate the respective reels R1, R2, R3.

Moreover, the main control substrate 71 is connected with the operating buttons 11. The operating buttons 11 include a stop button for inputting an instruction to stop the reels R1, R2, R3, a start button, a collect button, a bet button and the like. A signal corresponding to the push of the operating buttons 11 is inputted into the main CPU 32 via the I/O port 39.

In addition, the main control substrate 71 is connected with a bill validator 58, a coin counter 59, a ticket printer 14, a card reader 15, a communication interface 69 and a sensor 91.

The bill validator 58 reads an image of bill inserted into the bill insertion slot 13 and receives the normal bill in the cabinet 3. In addition, when receiving the normal bill, the bill validator 58 outputs an input signal to the main CPU 32 based on an amount of the bill. The main CPU 32 stores a credit-number in the RAM 33, which corresponds to the amount of bill transmitted by the input signal.

The coin counter 59 is provided in the coin insertion slot 12. The coin counter 59 identifies whether the coin inserted into the coin insertion slot 12 by a player is normal or not. When the coin counter 59 detects the abnormal coin, it discharges the abnormal coin to a coin tray 19. In addition, the coin counter 59 outputs an input signal to the main CPU 32 when it detects a normal coin.

The ticket printer 14 prints a barcode on a ticket, in which predetermined data is coded, based on the control signal outputted from the main CPU 32. The predetermined data includes credit-number stored in the RAM 33, the day and time and identification number of the gaming machine 1. The ticket printer 14 outputs a ticket having the barcode attached thereto.

The card reader 15 reads the data from a smart card to transmit it to the main CPU 32, or writes the data to the smart card based on a control signal from the main CPU 32.

The communication interface 69 is provided to communicate with a host computer equipped in the game arcade, through the communication line.

The sensor 91 is provided in the receiver 42 of the effect device 5A. The sensor 91 senses the ball 41 that passes to the inside of the receiver 42 and outputs a sensing signal to the main CPU 32.

In addition, the main control substrate 71 comprises an illumination effect driving circuit 61, a hopper driving circuit 63, a payout completion signal circuit 65, an indicator driving circuit 67 and an effect device driving unit 68.

The illumination effect driving circuit 61 outputs an effect signal that enables the light-emitting unit 20 to execute an illumination effect. The light-emitting unit 20 consists of many lamps or LED including the side lamps 22, the speaker lamps 24, the under lamps 25 and the top lamps 26.

The hopper driving circuit 63 drives a hopper 64 under control of the main CPU 32. The hopper 64 executes an operation of paying out a coin and pays out the coin to the coin tray 19. The payout completion signal circuit 65 is inputted with data of the coin-number from a coin detection unit 66 connected thereto. The payout completion signal circuit 65 inputs a signal, which notifies payout completion of the coin when the coin-number reaches a predetermined number, to the main CPU 32. The coin detection unit 66 measures the number of coins paid out by the hopper 64 and inputs data of the measured number to the payout completion signal circuit 65. The indicator driving circuit 67 controls display operations of various indicators such as payout-number indicator 8, credit-number indicator 9, liquid crystal panel 5C and the like.

The effect device driving unit 68 controls the driving of the effect device 5A when a bonus game is executed. In other words, the effect device driving unit 68 opens/closes the opening/closing hole 44 by the opening/closing device 92 when a bonus game is executed, horizontally moves the receiver 42 by the receiver moving device 93, horizontally moves the inhibitor 43 by the inhibitor moving device 94 and collects the ball 41 in the drop area 48 into the storage area 47 by the collection device 95.

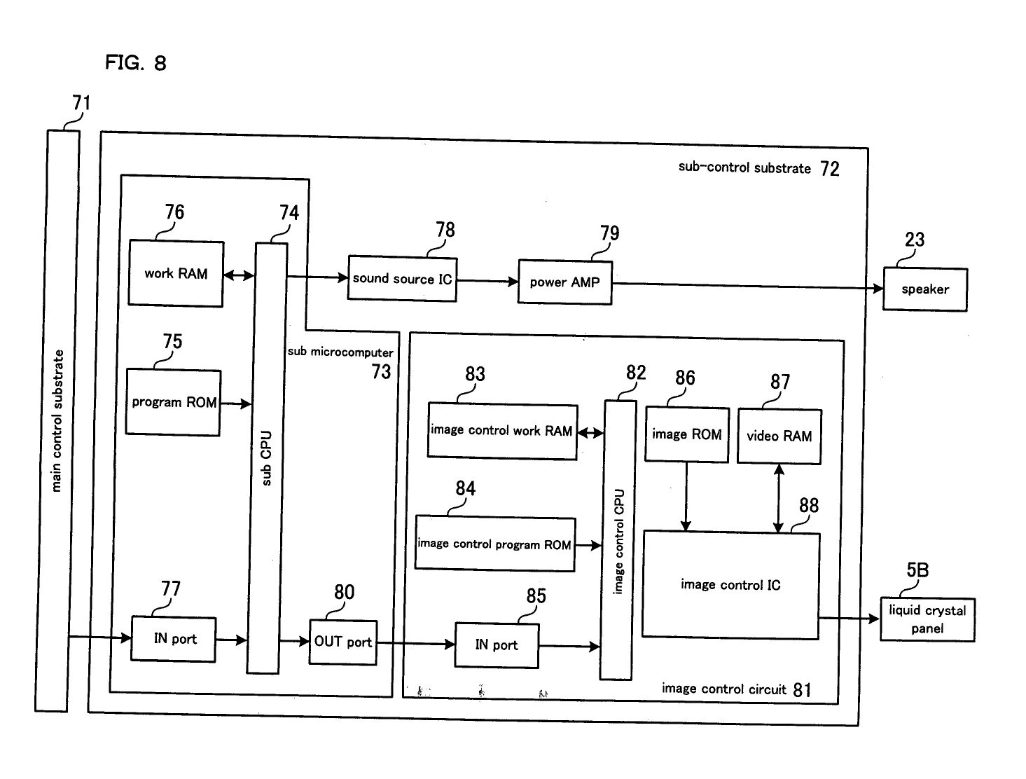

Further, the main control substrate 71 is connected with a sub-control substrate 72. As shown in FIG. 8, the sub-control substrate 72 performs a display control of the liquid crystal panel 5B of the variable indicator 4B, and an output control of a voice sound by the speaker 23, based on commands inputted from the main control substrate 71. The sub-control substrate 72 is comprised on a circuit substrate different from the circuit substrate constituting the main control substrate 71. The sub-control substrate 72 has a microcomputer 73 (hereinafter, referred to as “sub microcomputer 73”) as a main component. In addition, the sub-control substrate 72 has a sound source IC 78 controlling a voice sound outputted from the speaker 23, a power AMP 79 serving as an amplifier and an image control circuit 81 for controlling the display of the liquid crystal panel 5B.

The sub microcomputer 73 has a sub CPU 74 that performs a control operation in accordance with a control command transmitted from the main control substrate 71, a program ROM 75 serving as a memory device, a work RAM 76, an IN port 77 and an OUT port 80. Although the sub-control substrate 72 does not have a clock pulse generating circuit, a frequency dividing circuit, a random number generator and a sampling circuit, it executes a random number sampling on the operating program of the sub CPU 74. The program ROM 75 stores a control program that is executed in the sub CPU 74. The work RAM 76 serves as a temporary memory device when the control program is executed in the sub CPU 74.

The image control circuit 81 has an image control CPU 82, an image control work RAM 83, an image control program ROM 84, an IN port 85, an image ROM 86, a video RAM 87 and an image control IC 88. The image control CPU 82 determines an image that is displayed in the liquid crystal panel 5B, in accordance with the image control program stored in the image control program ROM 84, based on a parameter that is set in the sub microcomputer 73.

The image control program ROM 84 stores an image control program that is related to a display in the liquid crystal panel 5B, or various selection tables. The image control work RAM 83 serves as a temporary memory device when the image control program is executed in the image control CPU 82. The image control IC 88 forms an image corresponding to the content determined in the image control CPU 82 and outputs it to the liquid crystal panel 5B.

The image ROM 86 stores dot data for forming an image. The video RAM 87 serves as a temporary memory device when an image is formed in the image control IC 88.

(Operation of the Gaming Machine 1)

In the followings, a process that is performed in the gaming machine 1 will be described. As the main CPU 32 reads out and executes a game program, the gaming machine 1 progresses a game.

(Game Executing Process)

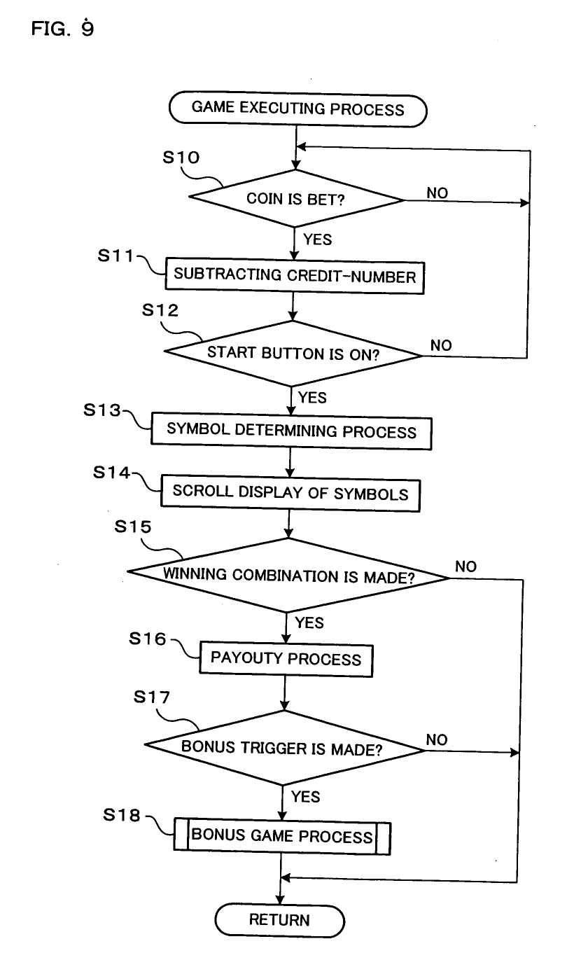

The main CPU 32 of the gaming machine 1 carries out a game executing process routine shown in FIG. 9. The game executing process routine will be described below.

Firstly, the main CPU 32 determines whether a coin is bet or not (S10). In this process of S10, it is determined whether an input signal caused due to a push of the bet button is received or not. When a coin is not bet (S10, NO), the main CPU 32 re-executes the step of S10, so that it waits for the process until a coin is bet.

In the mean time, when a coin is bet (S10, YES), the credit-number stored in the RAM 33 is subtracted in accordance with the coin-number (S11). In addition, when the number of coins bet is greater than the credit-number stored in the RAM 33, the step of S11 is re-executed without subtracting the credit-number. In addition, when the number of coins bet exceeds the upper limit (in this embodiment, 50 pieces) allowing a player to bet a coin in one game, a step of S12 is executed without subtracting the credit-number.

Next, the main CPU 32 determines whether a start button is ON or not (S12). When the start button is not ON (S12, NO), the process is returned to the step of S10. In addition, when the start button is not ON (for example, the start button is not ON and an instruction to end the game is inputted), it is canceled the subtraction result of the credit-number in the step of S11.

In the mean time, when the start button is ON (S12, YES), the main CPU 32 performs a symbol determining process (S13). In the symbol determining process of S13, the main CPU 32 executes a stop symbol determining program stored in the RAM 33 to determine a symbol matrix including the three symbols 180 to be stopped on the payline L.

Then, the main CPU 32 scroll-displays the symbols 180 of the display windows 7L, 7C, 7R (S14). After scrolling the symbols 180, the main CPU 32 stops (i.e., rearranges) the symbol matrix determined in the step of S13 in the display windows 7L, 7C, 7R.

Then, the main CPU 32 determines whether a combination is made or not, i.e., whether a combination of the symbols 180 stopped on the payline L is a winning combination or not (S15). When the combination is not a winning combination (S15, NO), the main CPU 32 ends this routine. In the mean time, when the combination is a winning combination (S15, YES), the main CPU 32 executes a payout process (S16). In the payout process of S16, the main CPU 32 calculates a payout-number of coins, based on the winning combination made. When the coins to be paid out are stored, the main CPU 32 adds a predetermined number of credits to the credit-number stored in the RAM 33. In the mean time, when the coins are paid out, the main CPU 32 transmits a control signal to the hopper 64 to pay out a predetermined number of coins to the coin tray 19.

Then, the main CPU 32 determines whether a bonus trigger is made as a winning combination (S17). In this embodiment, the bonus trigger is such that a combination of “APPLE” is arranged on the payline L. Therefore, in the process of S17, the main CPU 32 determines whether a combination of “APPLE” is arranged on the payline L. When it is determined that a bonus trigger is not made (S17, NO), the main CPU 32 ends this routine. In the mean time, when it is determined that a bonus trigger is made (S17, YES), the main CPU 32 executes a bonus game process (S18). The bonus game process of S18 will be described later. Then, after executing the bonus game process of S18, the main CPU 32 ends this routine.

(Bonus Game Process)

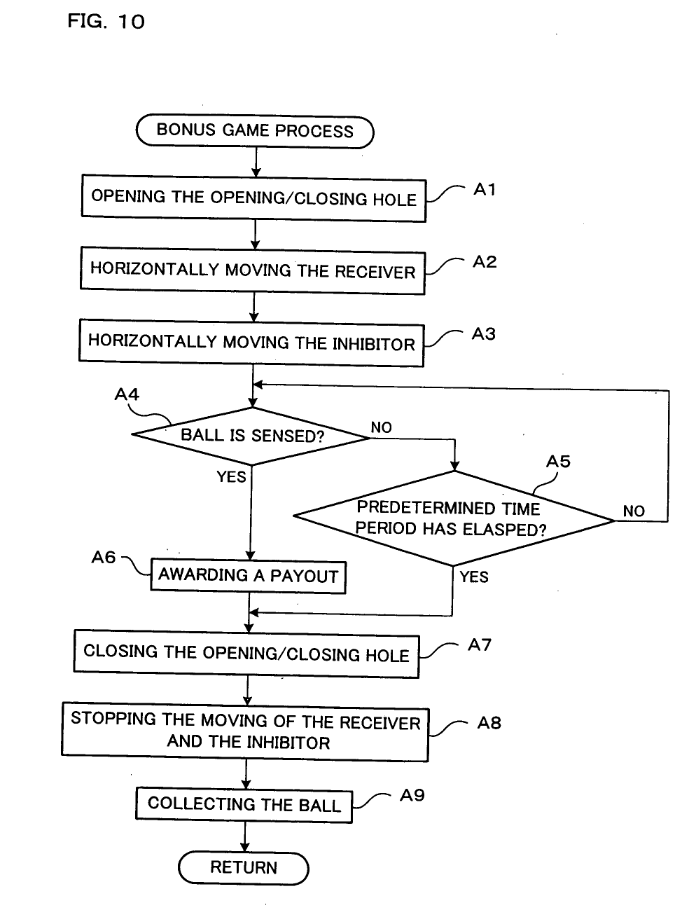

The main CPU 32 of the gaming machine 1 executes a bonus game process routine shown in FIG. 10 when a bonus trigger is made in the step of S17 of FIG. 9 (S17, YES). In the followings, the bonus game process routine shown in FIG. 10 will be described.

Firstly, the main CPU 32 opens the opening/closing hole 44 of the effect device 5A (refer to FIG. 5) (A1). Thereby, the ball 41 stored in the storage area 47 is dropped from the opening/closing hole 44. The ball collides with the pins 46 and is dropped in the drop area 48 while changing the dropping direction randomly. In addition, the main CPU 32 horizontally moves the receiver 42 of the effect device 5A with the receiver moving device 93 (A2) and horizontally moves the inhibitor 43 with the inhibitor moving device 94 (A3).

Then, the main CPU 32 determines whether the sensor 91 in the receiver 42 of the effect device 5A senses the ball 41 (A4). When it is determines that the sensor 91 does not sense the ball 41 (A4, NO), the main CPU 32 determines whether a predetermined time period has elapsed (A5). Here, the predetermined time period means a time period a little longer than a time period that is necessary for the dropped ball 41 to pass to the drop area 48 and to reach the bottom wall 48a of the drop area 48. When it is determined that the predetermined time period has not elapsed (A5, NO), the main CPU 32 re-executes the process of A4 to repeatedly determine whether the sensor 91 senses the ball 41 until the ball 41 reaches the bottom wall 48a of the drop area 48.

In the process of A4, when it is determined that the sensor 91 senses the ball 41 (A4, YES), the main CPU 32 awards a payout in a bonus game (A6). In other words, in the process of A6, the main CPU 32 calculates the payout-number of coins in accordance with the payout in a bonus game and adds the credit of the calculated payout-number to the credit-number stored in the RAM 33 or pays out the coins of the calculated payout-number to the coin tray 19.

When it is determined in the process of A5 that the predetermined time period has elapsed (A5, YES), or after executing the process of A6, the main CPU 32 closes the opening/closing hole 44 of the effect device 5A (A7) and stops the horizontal moving of the receiver 42 and the inhibitor 43 (A8). Then, the main CPU 32 collects the ball 41 in the drop area 48 into the storage area 47 using the collection device 95 (A9) and ends the sub routine.

Like this, in the bonus game process routine, the main CPU 32 of the gaming machine 1 executes a bonus game in which the ball 41 is physically dropped, and awards a payout when the dropped ball 41 is received in the receiver 42 being horizontally moved. In other words, there may occur a case where a payout is accidentally awarded. Therefore, a new entertainment characteristic can be provided.

The above descriptions have been provided with regard to the characteristic parts so as to understand the invention more easily. However, the invention is not limited to the embodiment as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be easily derived from the spirit of the invention described in the specification. Accordingly, it should be considered that the invention covers equivalent structures thereof without departing from the spirit and scope of the invention as defined in the following claims. Further, the abstract is provided so that United States Patent and Trademark Office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

In addition, the above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

What is claimed is:

1. A gaming machine comprising:
a display that arranges a plurality of symbols;
an effect device that comprises a ball to be dropped and a plurality of pins with which the ball collides while being dropped; and
a controller that operates
(a) to rearrange the symbols;
(b) to determine a win based on a relation of the symbols rearranged;
(c) to drop the ball when a predetermined condition is fulfilled; and
(d) to award a payout when the dropped ball reaches a specific location.

2. The gaming machine according to claim 1,
wherein the effect device further comprises a receiver capable of receiving the ball, and
wherein the controller operates: (d) to award a payout when the dropped ball is received in the receiver.

3. The gaming machine according to claim 1,
wherein the effect device further comprises a receiver capable of receiving the ball and an inhibitor that inhibits the ball from being received in the receiver,
wherein the controller operates:
(c) to drop the ball and to horizontally move the receiver and the inhibitor when a predetermined condition is fulfilled; and
(d) to award a payout when the dropped ball is received in the receiver.

4. A playing method of a gaming machine that repeatedly performs a unit game in which a plurality of symbols are rearranged, the method comprising the steps of:
executing a bonus game in which a ball is dropped while colliding with a plurality of pins, when a predetermined condition is fulfilled; and
awarding a payout when the dropped ball reaches a specific location.

5. The playing method according to claim 4, wherein the step of executing a bonus game further horizontally moves a receiver capable of receiving the ball when a predetermined condition is fulfilled; and
wherein the step of awarding a payout awards a payout when the dropped ball is received in the receiver.

6. The playing method according to claim 4, wherein the step of executing a bonus game further horizontally moves a receiver capable of receiving the ball and an inhibitor that inhibits the ball from being received in the receiver, when a predetermined condition is fulfilled; and
wherein the step of awarding a payout awards a payout when the dropped ball is received in the receiver.
